(19) United States
(12) Patent Application Publication
(10) Pub. No.: US 2012/0187270 A1
(43) Pub. Date: Jul. 26, 2012

(54) MOUNTING DEVICE FOR DISHWASHERS

(76) Inventors: MICHAEL E. HAARLANDER, Vero Beach, FL (US); THOMAS M. HAARLANDER, Vero Beach, FL (US)

(21) Appl. No.: 13/331,120

(22) Filed: Dec. 20, 2011

Related U.S. Application Data
(60) Provisional application No. 61/425,045, filed on Dec. 20, 2010.

(51) Int. Cl. F16M 13/00; E04F 19/00

(52) U.S. Cl. 248/544; 52/741.1

(57) ABSTRACT

A mounting device for mounting a dishwasher or similar appliance into a space, comprising a base permanently fastened or affixed to a flat surface, such as the underside of a countertop, and means for removably and securely attaching a mounting bracket, tongue or strip on the dishwasher or other appliance to the mounting device. The base may be any suitable shape, including, but not limited to, a circle, oval, square, rectangle, triangle, parallelogram, trapezoid, pentagon, hexagon, heptagon, octagon, or any similar polygon. The means for attachment may comprise a post, stud or rod extending outward from the base. Alternatively, the means for attachment may comprise one or more receiving holes, adapted to receive a screw or bolt. The mounting device may be affixed to the flat surface by means of adhesive.

This application claims benefit of and priority to U.S. Provisional Application No. 61/425,045, filed Dec. 20, 2010, by Michael E. Haarlander, et al., and is entitled to that filing date for priority. The specification, figures and complete disclosure of U.S. Provisional Application No. 61/425,045 are incorporated herein by specific reference for all purposes.

### FIELD OF INVENTION

This invention relates to a device and apparatus to assist in the installation of dishwashers and similar appliances.

### BACKGROUND OF THE INVENTION

Mounting a dishwasher under a countertop typically is performed by inserting a screw through holes in a mounting bracket, tongue or clip affixed to the body of the dishwasher, and then screwing the screw into the underside of the countertop. After installation one or more of the screws may rip out of the countertop due to vibrations in operation of the appliance, thus damaging the countertop and requiring expensive repairs.

Accordingly, what is needed is an easier and more convenient method of installing a dishwasher or similar appliance without damaging or inserting screws or bolts into the countertop or other surfaces.

### SUMMARY OF INVENTION

In various exemplary embodiments, as shown in the accompanying figures, the invention comprises a base with two sides, with a back side to be attached to a flat surface (e.g., the underside of the countertop, or the sides of the space where the dishwasher or other appliance is to be installed). The base may be any suitable shape, including, but not limited to, a circle, oval, square, rectangle, triangle, parallelogram, trapezoid, pentagon, hexagon, heptagon, octagon, or any similar polygon. The front side comprises the means for attaching the mounting bracket, tongue or clip on the dishwasher or appliance to the invention, as described in more detail below.

In one exemplary embodiment, the present invention comprises a mounting post, stud or rod extending upwards from the top side of the base. A cover, cap or nut may be used to secure the mounting bracket or clip on the dishwasher or appliance to the mounting post. The post, stud or rod may extend upwards from the middle of the base, or may be positioned closer to the outer edge or one side of the base.

The back side of the base (i.e., opposite the post, stud or rod) is affixed to a surface, such as the underside of a countertop, in the area of the dishwasher. In one embodiment, the mounting post is affixed by application of an adhesive to the back side base. In an alternative self-adhesive embodiment, an adhesive and adhesive liner may be previously applied to the mounting post, so that the user only needs to remove the liner to expose the adhesive prior to installation.

In one embodiment, the mounting post is affixed to the underside of the countertop near the front edge of the counter top, in a position where the mounting brackets or clips attached to the dishwasher body can be placed over the mounting post (i.e., the mounting post extends through a hole in the mounting bracket or clip). The cover, cap or nut may then be placed over the mounting post to secure the mounting bracket or clip.

In an exemplary embodiment, the post, stud or rod is threaded, and receives a cover, cap or nut with matching internal threads (i.e., the cover, cap or nut is screwed onto the post, stud or rod). In another embodiment, the top of the post, stud or rod has a notch, rim or head, adapted to snap into a corresponding rim, notch or indentation inside the cover, cap or nut. The cover or cap may also snap onto the top of the post, stud or rod. Other means of securing the mounting bracket or clip to the mounting post may be used, as known in the art.

The diameter and length of the post, stud or rod may vary. Likewise, the size and thickness of the base also may vary. In another exemplary embodiment, two or more posts, studs or rods may extend upwards from the base. In one exemplary embodiment, the base comprises a rectangular strip with a plurality of posts, studs or rods spaced thereon.

In another exemplary embodiment, one or more holes or indentations may be located in the base around the post, stud or rod.

In yet another exemplary embodiment, the base has an elevated or thickened portion with one or a plurality of receiving holes therein. Separate screws or bolts can be screwed into or otherwise inserted into the receiving holes and thereby fastened to the mounting device. The thickened portion may comprise the entire length and width of the base, or only a portion thereof. The thickened portion may be solid or hollow, in whole or in part.

In one exemplary embodiment, as shown in FIGS. 3 and 4, the base is an elongated rectangular strip with a plurality of receiving holes. The holes may be configured as a single line or multiple lines of spaced holes. Where multiple lines of holes are present, adjacent lines may be offset. The receiving holes may cover a portion or the entirety of the surface. In one embodiment, the base strips are short, and multiple base strips are used, one for each mounting bracket or tongue. In an alternative embodiment, the base strip is sufficiently long to extend under all mounting brackets or tongues on the dishwasher, and thus a single strip can be used for installation. This configuration further has the advantage of requiring less precise placement of the mounting device, as there are multiple receiving holes to align with the mounting brackets or tongues.

The invention may be made of any suitable material, including but not limited to plastic, metal, nylon or wood, or a combination thereof. Likewise, the present device may be any color, or multi-colored, or transparent.

The present invention may be used with other appliances as well as dishwashers. It also may be used for other purposes where a mounting post or bolt may be needed without screwing or drilling into the underlying surface.

### BRIEF DESCRIPTION OF THE DRAWINGS

FIG. 1 shows top views of various configurations of mounting posts in accordance with various embodiments of the present invention.

FIG. 2 shows side views of mounting posts in accordance with various embodiments of the present invention.

FIG. 3 shows a perspective and other views of a mounting post with a circular base in accordance with an exemplary embodiment of the present invention.

FIG. 4 shows a perspective and other views of a mounting device with a circular base in accordance with another exemplary embodiment of the present invention.

FIGS. 5-7 shows views of a mounting strip with receiving holes in accordance with another exemplary embodiment of the present invention.

FIG. 8 shows views of a mounting strip with slots in accordance with yet another exemplary embodiment of the present invention.

### DETAILED DESCRIPTION OF EXEMPLARY EMBODIMENTS

In various exemplary embodiments, as shown in the accompanying figures, the invention comprises a base 10 with two sides (a back and front). The back side is to attached or fastened to a flat surface (e.g., the underside of the countertop, or the sides of the space where the dishwasher or other appliance is to be installed). The base may be any suitable shape, including, but not limited to, a circle, oval, square, rectangle, triangle, parallelogram, trapezoid, pentagon, hexagon, heptagon, octagon, or any similar polygon. The front side comprises the means for attaching the mounting bracket, tongue or clip on the dishwasher or appliance to the invention, as described in more detail below.

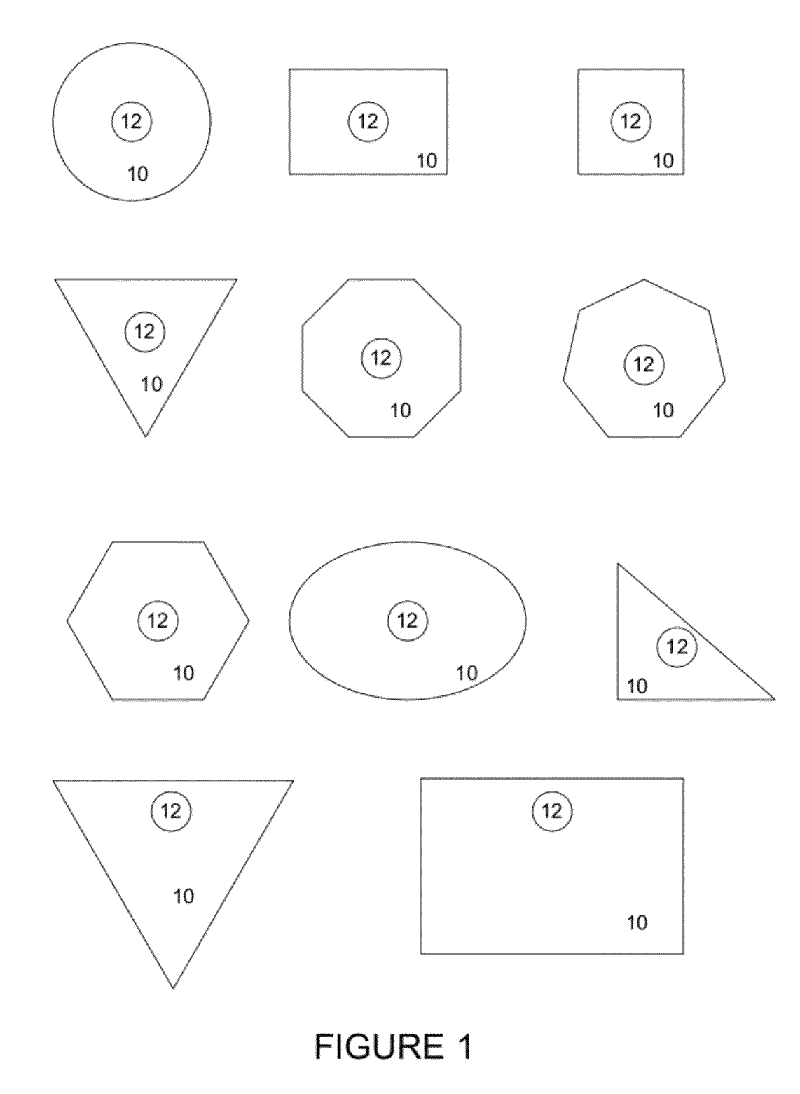

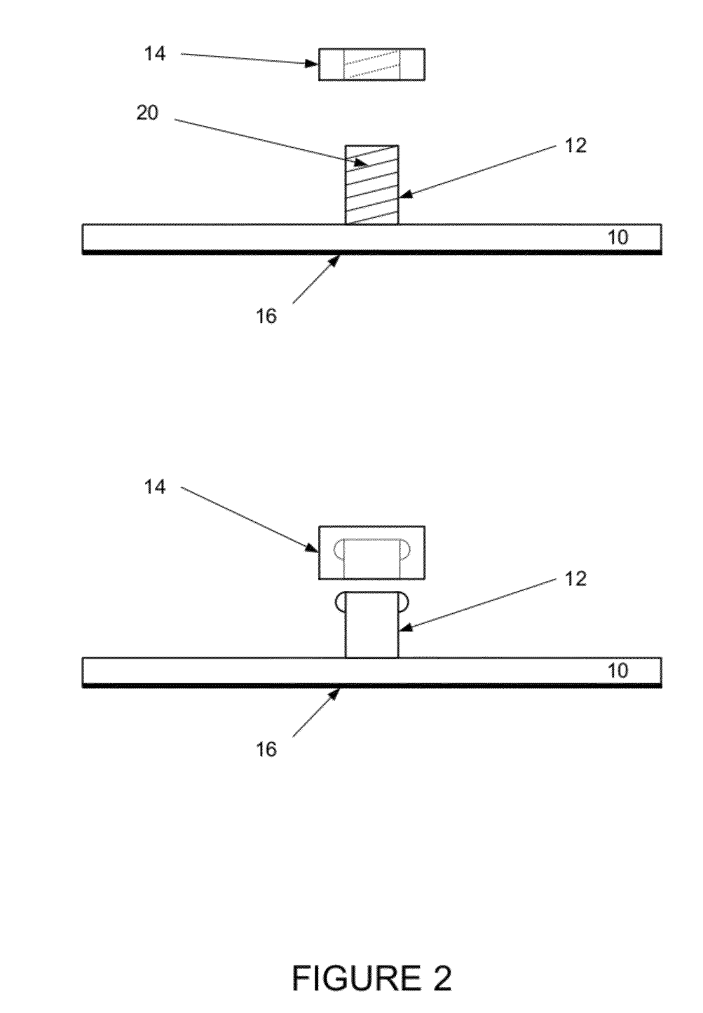

In one exemplary embodiment, as seen in FIGS. 1 and 2, the present invention comprises a mounting post, stud or rod 12 extending upwards from the front side of the base 10. A cover, cap or nut 14 may be used to secure the mounting bracket or clip on the dishwasher or appliance to the mounting post. The post, stud or rod may extend upwards from the middle of the base, or may be positioned closer to the outer edge or one side of the base, as seen in FIG. 1.

The back side of the base (i.e., opposite the post, stud or rod) is affixed to a surface, such as the underside of a countertop, in the area of the dishwasher. In one embodiment, the mounting post is affixed by application of an adhesive 16 to the back side of base. In an alternative self-adhesive embodiment, an adhesive and adhesive liner may be previously applied to the mounting post, so that the user only needs to remove the liner to expose the adhesive prior to installation. In yet another embodiment, double-faced tape 18 may be used for affixation. Very high bond pressure sensitive materials (e.g., 3M VHB-54, or the like) may be used.

In one embodiment, the mounting post is affixed to the underside of the countertop near the front edge of the counter top, in a position where the mounting brackets or clips attached to the dishwasher body can be placed over the mounting post (i.e., the mounting post extends through a hole in the mounting bracket or clip). The cover, cap or nut may then be placed over mounting post to secure the mounting bracket or clip.

In an exemplary embodiment, the post, stud or rod is threaded 20, and receives a cover, cap or nut 14 with matching internal threads (i.e., the cover, cap or nut is screwed onto the post, stud or rod). In another embodiment, the top of the post, stud or rod has a notch, rim or head, adapted to snap into a corresponding rim, notch or indentation inside the cover, cap or nut. The cover or cap may also snap onto the top of the post, stud or rod. Other means of securing the mounting bracket or clip to the mounting post may be used, as known in the art.

The diameter and length of the post, stud or rod may vary. Likewise, the size and thickness of the base also may vary. In another exemplary embodiment, two or more posts, studs or rods may extend upwards from the base. In one exemplary embodiment, the base comprises a rectangular strip with a plurality of posts, studs or rods spaced thereon. In another exemplary embodiment, one or more holes or indentations may be located in the base around the post, stud or rod.

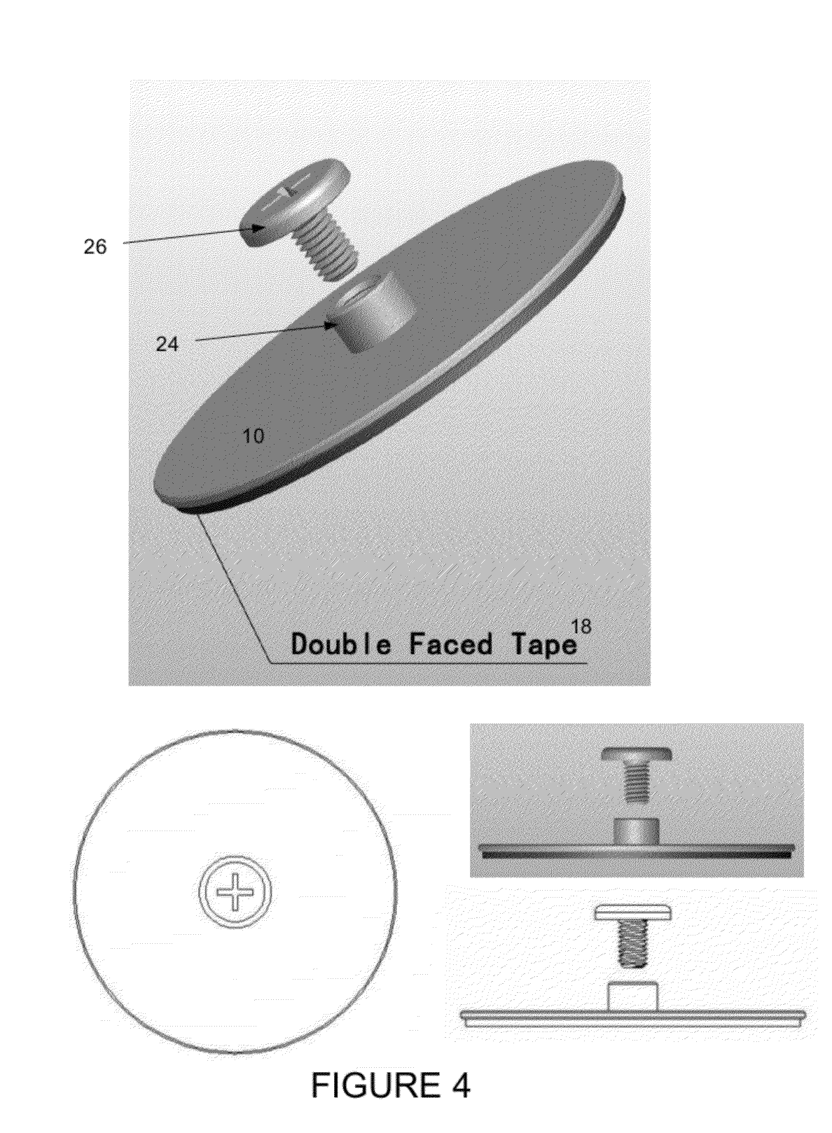

In another exemplary embodiment, the attachment means comprises a receiving mount 24 extending upward from the front of the base, as seen in FIG. 4. The receiving mount has a central hole that may be threaded. A bolt, screw or similar device 26 is inserted into central hole of the receiving mount. In the embodiment shown, a bolt or screw with matching threads is screwed into the threaded receiving mount. The size, positioning, number, adhesive backing, and other characteristics are otherwise similar to the mounting post embodiment described above.

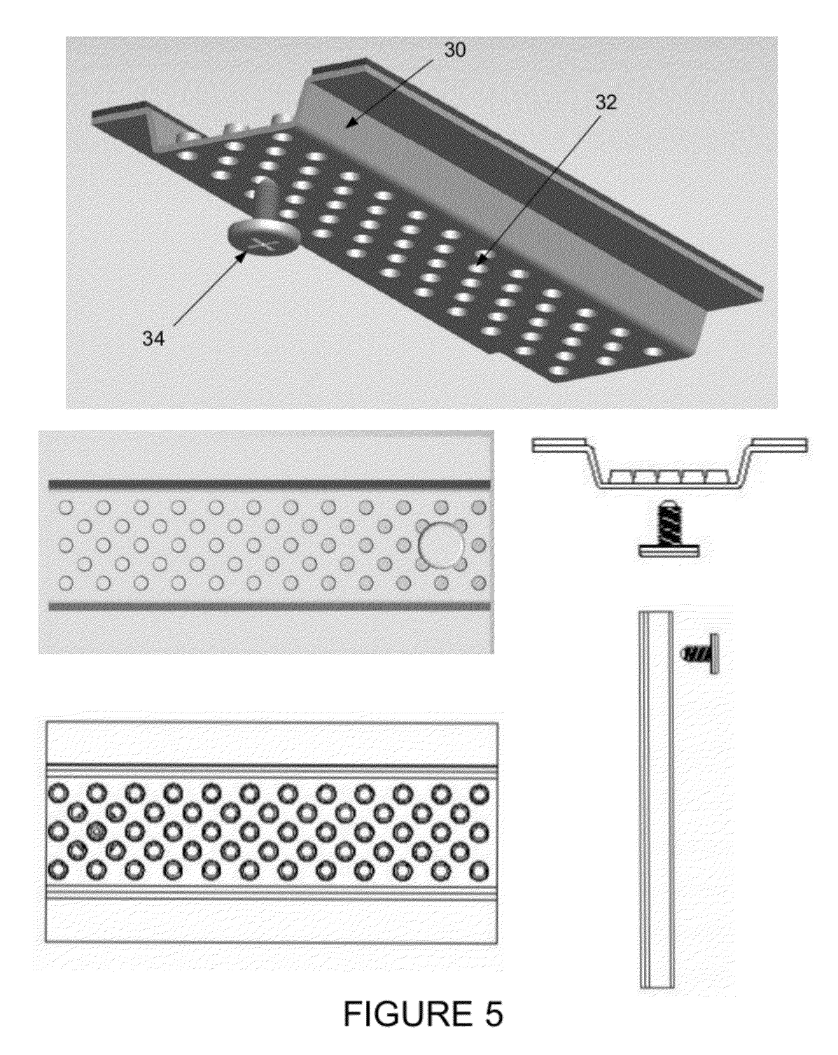

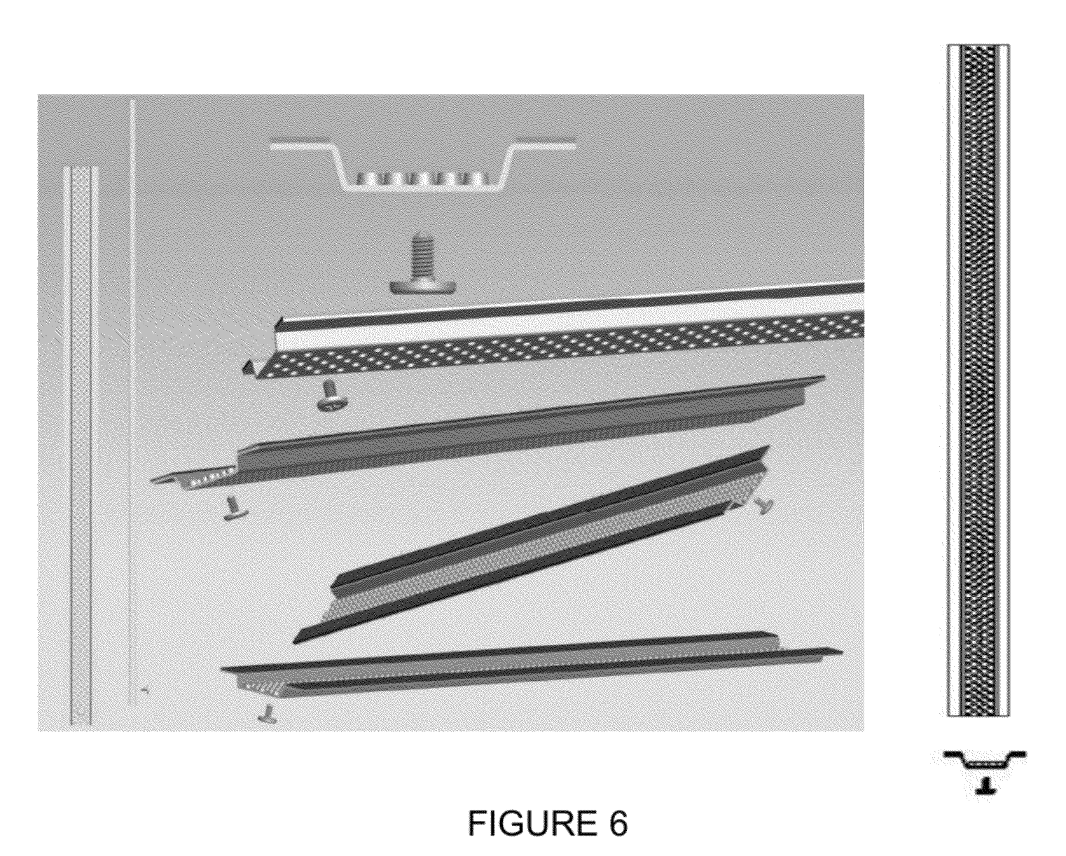

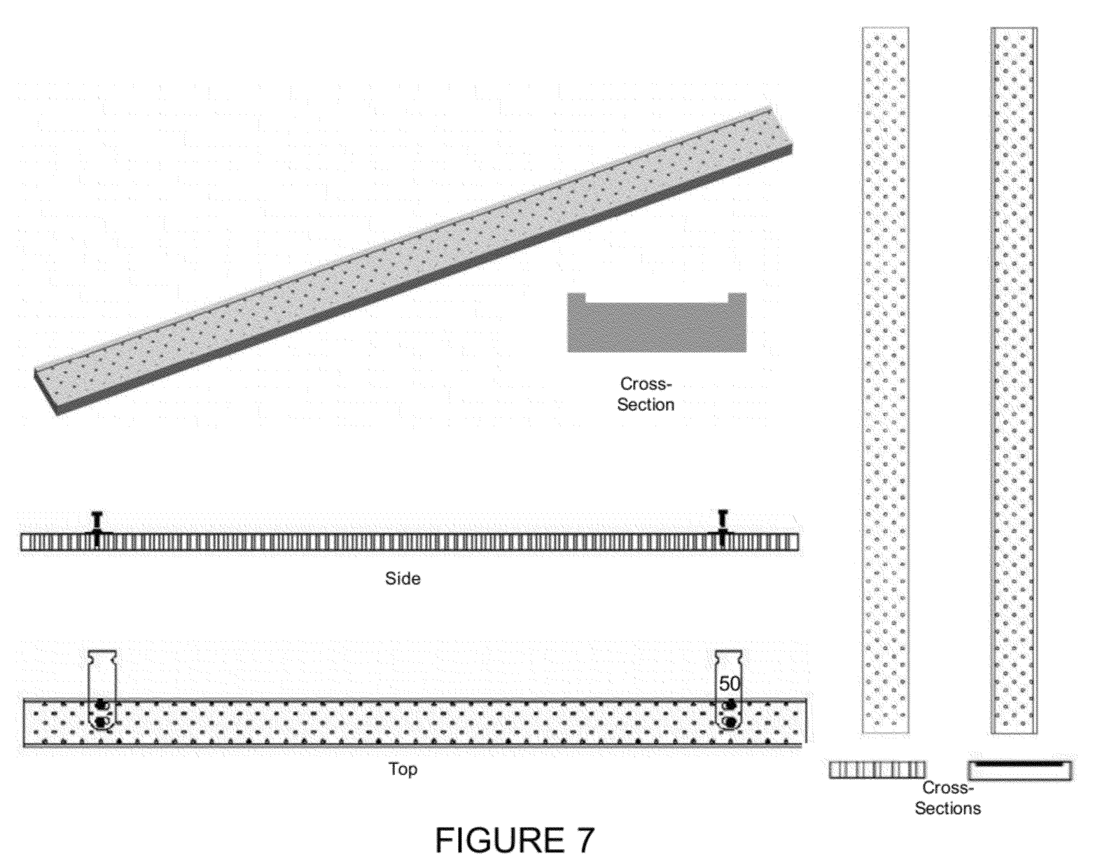

In yet another exemplary embodiment, as seen in FIGS. 5-7, the base has an elevated or thickened portion 30 with one or a plurality of receiving holes 32 therein. Separate screws or bolts 34 can be screwed into or otherwise inserted into the receiving holes 32 and thereby fastened to the mounting device. The elevated or thickened portion may comprise the entire length and width of the base, or only a portion thereof. The elevated thickened portion may be solid or hollow, in whole or in part.

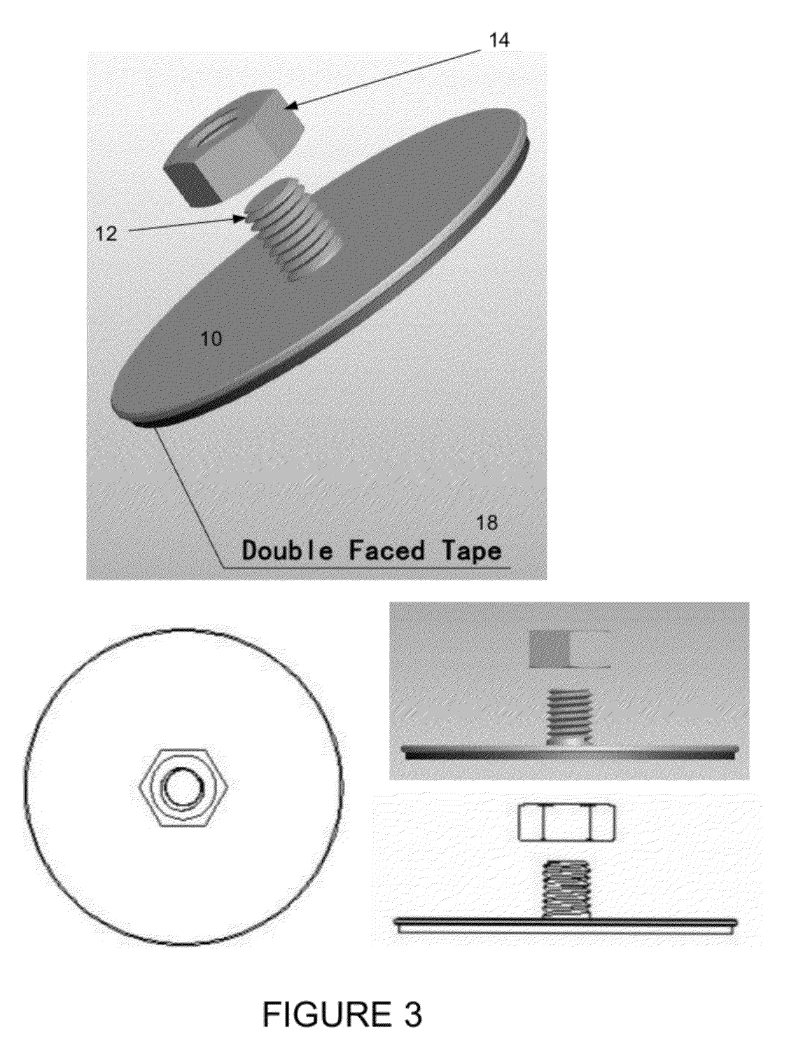

In one exemplary embodiment, as shown in FIGS. 3 and 4, the base is an elongated rectangular strip with a plurality of receiving holes. The strip may be short (e.g., approximately 4 inches long) or long (e.g., approximately 18 to 28 inches long). The holes may be configured as a single line or multiple lines of spaced holes. Where multiple lines of holes are present, adjacent lines may be offset. The receiving holes may cover a portion or the entirety of the surface. In one embodiment, the base strips are short, and multiple base strips are used, one for each mounting bracket or tongue 50. In an alternative embodiment, the base strip is sufficiently long to extend under all mounting brackets or tongues on the dishwasher, and thus a single strip can be used for installation. This configuration further has the advantage of requiring less precise placement of the mounting device, as there are multiple receiving holes to align with the mounting brackets or tongues.

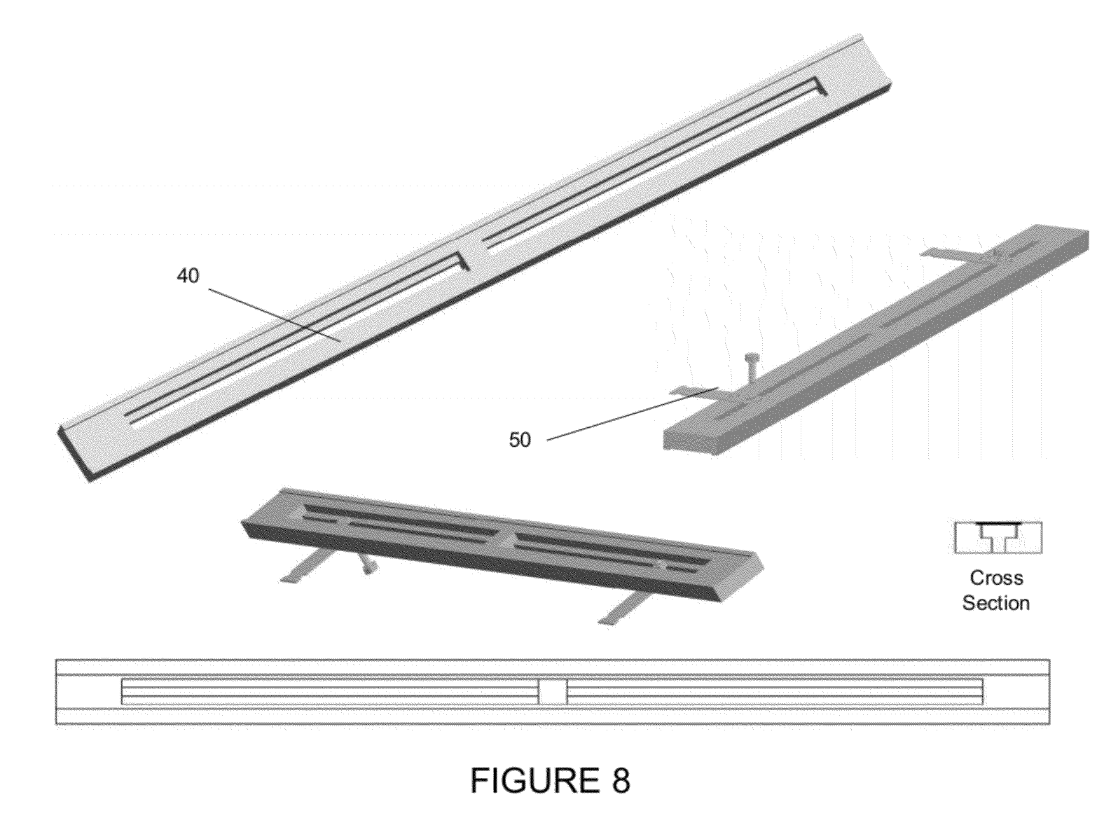

In an alternative embodiment, the strip may contain one or more slots or grooved openings 40, as seen in FIG. 8. The slots may be positioned in middle of the strip, and extend for up to the length of the strip (or to within a certain distance of the ends of the strip, e.g., to within approximately one inch). The middle of the strip may be elevated or thickened, as described above, or may be thinner than the edges, as seen in FIG. 8. In one embodiment, two or more slots may be positioned end-to-end, with a solid section in between to provide support and strength to the strip. A separate nut and bolt or screw may be used in conjunction with the slot, and moved laterally to fasten the mounting bracket or tongue 50, thereby accommodating different configurations of dishwashers. The size, positioning, number, adhesive backing, and other characteristics are otherwise similar to the receiving hole embodiment described above.

The invention may be made of any suitable material, including but not limited to plastic, metal, nylon, or wood, or a combination thereof. Likewise, the present device may be any color, or multi-colored, or transparent.

The present invention may be used with other appliances as well as dishwashers. It also may be used for other purposes where a mounting post or bolt may be needed without screwing or drilling into the underlying surface.

In one particular embodiment, the strip is approximately 23.5 inches long, 1.5 inches wide, and 0.5 inches in maximum thickness. Other dimensions may be used.

In one exemplary embodiment, the installation process of a dishwasher using the present invention is carried out as described below. Once the dishwasher is placed underneath the counter, it is properly leveled and positioned so that it is centered in the opening with proper gapping on each side as well as top to bottom centering. Typically, at this point the dishwasher will be able to tilt slightly forward from under the counter.

The next step is to temporarily place one or more of the devices of the present invention in position on the underside of the countertop (or other surface) to be able to secure the mounting brackets, tongues or clips on the dishwasher. The user can mark the area around the base of the devices so that once the adhesive backing is removed, the device (or devices) can be pressed into place easily in the exact area marked. In one configuration, the devices are aligned to be parallel to the front of the countertop or the cabinets on either side of the dishwasher space.

Prior to or after the marking step, the bottom of the countertop area where the devices are to be applied should be cleaned with isopropyl alcohol or similar cleaner. In one embodiment, an area extending 3 inches back from the front of the counter is cleaned, and ensured to be clean and free of debris.

The next step is removing the backing and pressing the adhesive-backed device into place using the markings as guidelines. Alternatively, an adhesive can be applied to the back of the base (or bases), and the device (or devices) pressed into place.

Next, the dishwasher is repositioned so the mounting brackets, tongues or clips are aligned properly with the mounting devices, and then secured thereupon. If the mounting device has an extended protrusion, post or bolt, the dishwasher is properly positioned so that a hole in the mounting bracket, tongue or clip fits over the protrusion, post or bolt, and is clipped, snapped, or screwed into place, thus marrying all pieces tightly together to ensure that the dishwasher will not move from its installed position. If the mounting device has receiving holes, the dishwasher is properly positioned as above, and a bolt or screw is inserted through a corresponding hole in the mounting bracket, tongue or clip, and screwed or fastened in a receiving hole in the mounting device. A similar operation would apply for the embodiment with slots.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A mounting device for mounting a dishwasher or similar appliance, comprising:
a base with a front side and a back side, wherein the back side is adapted to be permanently fastened or affixed to a flat surface; and
means on the front side of the base for removably and securely attaching a mounting bracket, tongue or strip on a dishwasher or other appliance to the mounting device.

2. The device of claim 1, wherein the base is not screwed or bolted to the flat surface, and the flat surface is not penetrated.

3. The device of claim 1, further comprising an adhesive layer applied to the back side of the base.

4. The device of claim 3, further comprising a removable adhesive liner covering the adhesive layer.

5. The device of claim 1, further comprising double-faced adhesive tape applied to the back side of the base.

6. The device of claim 1, wherein the attachment means comprises a post or similar protrusion extending outward from the front side.

7. The device of claim 6, wherein the post or similar protrusion is threaded.

8. The device of claim 6, further comprising a nut or cap adapted to fit on the post or similar protrusion.

9. The device of claim 1, wherein the attachment means comprises a receiving mount extending outward from the front side, wherein the receiving mount comprises a threaded central hole.

10. The device of claim 1, wherein the attachment means comprises one or more receiving holes in the front side.

11. The device of claim 10, wherein the attachment means further comprises a screw or bolt adapted to be inserted into at least one of the one or more receiving holes.

12. The device of claim 10, wherein there are multiple lines of receiving holes, with the receiving holes evenly space within each line, and with holes in adjacent lines offset from each other.

13. The device of claim 1, wherein the attachment means comprises one or more slots or grooved openings in the front side.

14. The device of claim 1, wherein the base is rectangular.

15. The device of claim 1, wherein the base is circular.

16. The device of claim 1, wherein the base is solid.

17. The device of claim 1, wherein the base is hollow, in whole or in part.

18. A method of installing a dishwasher with mounting brackets, tongues or strips using the mounting device of claim 1, comprising the steps of:
positioning the dishwasher in the desired space under a countertop;
positioning one or more of said mounting devices on the underside of the countertop so as to be aligned with one or more mounting brackets, tongues or strips on the dishwasher;
marking the position of the mounting devices;
removing the dishwasher from the space, if necessary;
permanently affixing said mounting devices to the underside of the countertop;
repositioning the dishwasher so the one or more mounting brackets, tongues or strips are aligned with said mounting devices, if necessary; and
removably and securely attaching the one or more mounting brackets, tongues or strips to said mounting devices.

19. The method of claim 18, wherein the mounting device is a single rectangular strip with a back side and a front side, wherein the back side is affixed to the underside of the countertop and the front side comprises a plurality of receiving holes, and the step of attaching comprises inserting a screw or bolt through a hole in a mounting bracket, tongue or strip, and into one of said receiving holes.

20. The method of claim 18, wherein the step of permanently affixing comprises the step of removing an adhesive liner from an adhesive layer that has been previously applied to one side of the mounting device, and pressing the mounting device into place on the underside of the countertop.
